(19) United States
(12) Patent Application Publication
(10) Pub. No.: US 2007/0094240 A1
(43) Pub. Date: Apr. 26, 2007

(54) Diplomas express

(76) Inventor: Dion Dennis, Bronx, NY (US)

Correspondence Address: DION DENNIS, 1137 White Plains Rd, 2R, Bronx, NY, 10472, US

(21) Appl. No.: 11/229,209

(22) Filed: Oct. 26, 2005

(51) Int. Cl. G06F 17/00

(52) U.S. Cl. 707/3; 715/526

(57) ABSTRACT

Diplomas Express was designed to speed delivery of diplomas to students after they graduate. Currently, students have to wait a minimum of five months before they can receive their diplomas. This is due to sending a list of graduates' names, degree type, school, graduation date and Dean's name to a printing company. About two months goes by until the university receives diplomas. Then they are checked for accuracy, filed, some are sent to different departments. Then letters are sent to students advising them when and where they can pick up their diplomas. Another two months go by regarding the aforementioned. This creates frustration for students because they are anxious to get their diplomas that they have worked so hard to obtain. Diplomas Express can eliminate the wait to one month or less by printing diplomas in-house.

### BACKGROUND

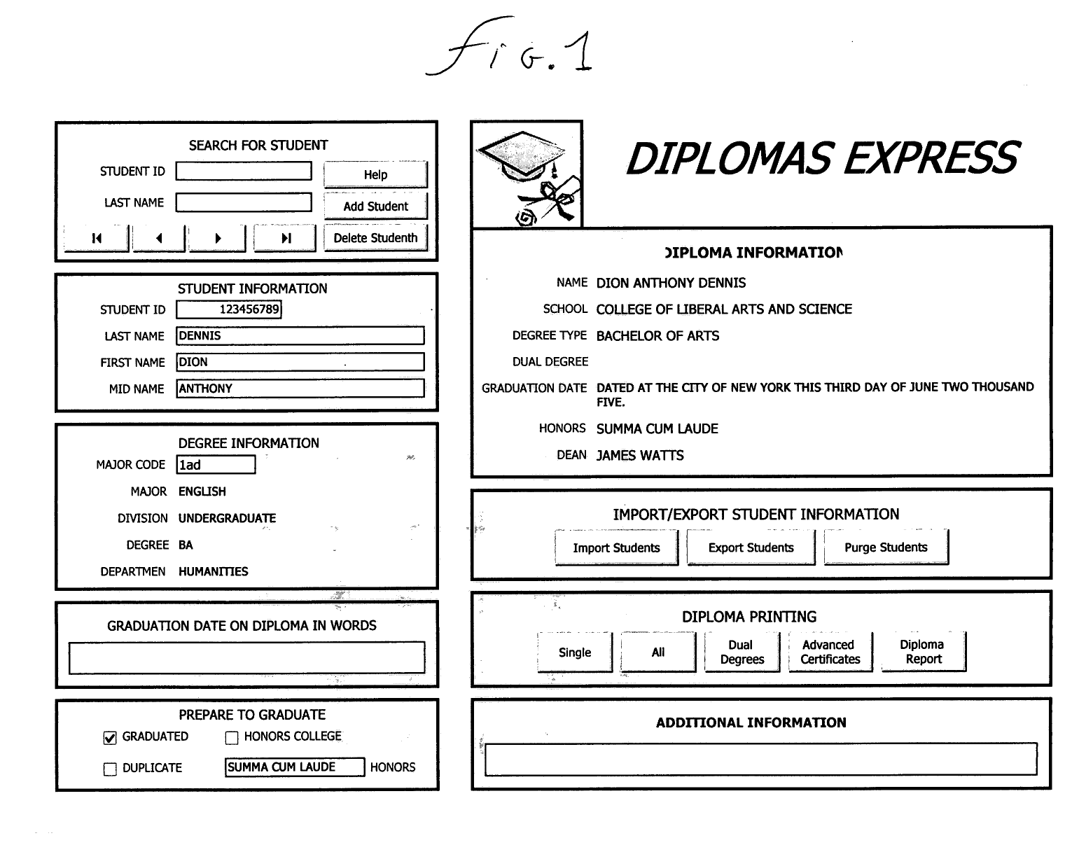

This is a user-friendly database that will be used to print diplomas and certificates for colleges. It was created using Microsoft Access. The requirements to use this database are: Microsoft Office with Access installed, Windows 98, 2000 or XP. The size of this database is 6.35 MB when it is installed. The main ingredient of this database is the Major Code. This determines what type of diploma will be printed. The students' major code combined with a query returns what type of diploma the graduated student will receive. In order for the Students' information to appear in Diplomas Express, it must be exported from the school's student management system. This exported file must be converted into an Excel file. The required fields in Excel before it can be imported are: Student ID (Social Security #), Last Name, First name, Middle name (Optional), Suffix (Optional) and Major code. Note: Social Security numbers are entered in this format: 123456789. When this information is imported or entered manually, the students are alphabetized automatically by last name. The “name” field in the diploma information section will concatenate the first name, middle name, last name and suffix. This is the field that will be printed on the diploma. The Major code determines what type of diploma the student will obtain. This code auto-populates various fields to minimize data-entry errors for the operator. The fields that auto-populate based on the Major code are: Major, Division, Degree, Department, School, Degree Type, Dual Degree and Dean. (See FIG. 1)

### TABLES

There are five defined tables in DIPLOMAS EXPRESS. They are: 1—APPLICANTS, 2—MAJORCODE, 3—DEGREECODE, 4—SCHOOLCODE AND 5—DEANCODE.

### Applicants Table

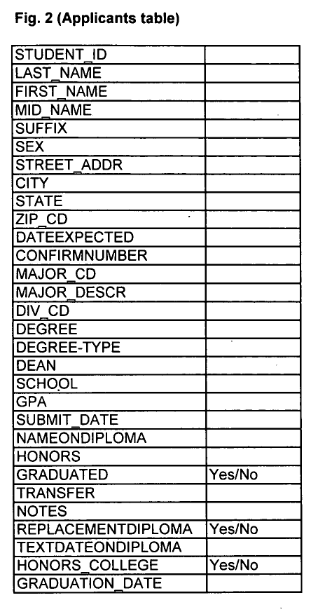

The applicants table is the main table that contains relevant student information. The student's information is entered via the main form then writes to the applicants table. (See FIG. 2)

### Majorcode Table

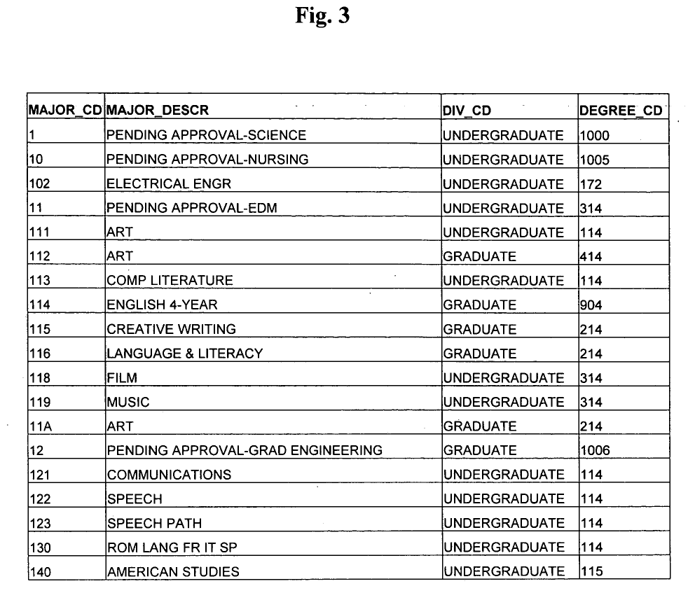

This major code is of primary importance. The major code is a single or three-digit alphanumeric code, i.e.: 1, 141, 1AD, CF2, 613. These codes are defined in a table, which lists the major description, division (graduate or undergraduate) and degree code. This returns what type of diploma a student will receive with the appropriate school, degree type and Dean's signature on the diploma. This is entered or imported into the major code field. (See FIG. 3.)

### Degreecode Table

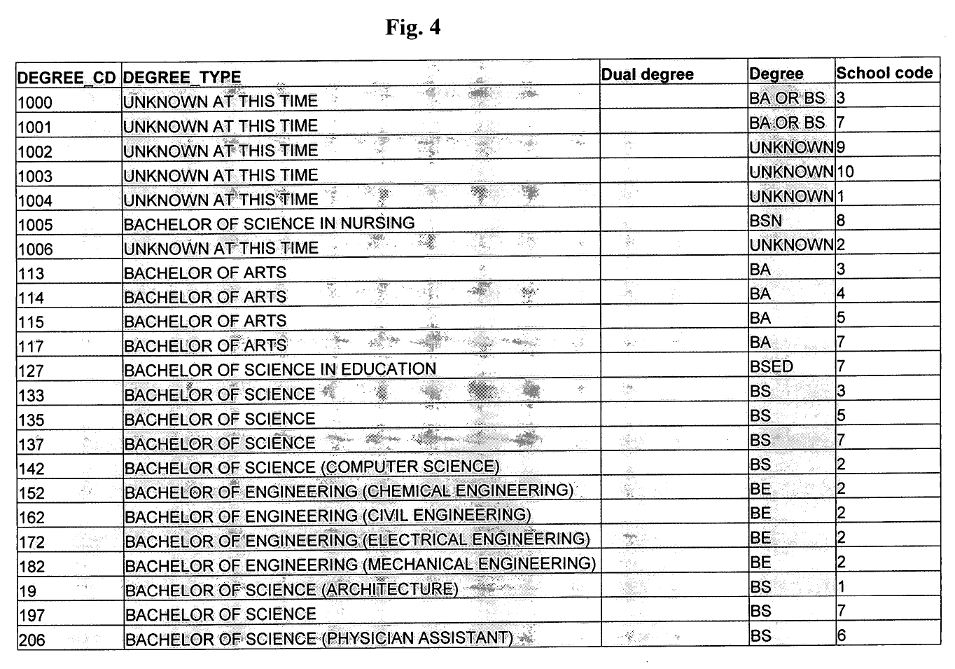

The degree code table defines what degree type will appear on diploma as well as dual degrees. Degree type can be Bachelor of Arts, Master of Arts, Bachelor of Science, etc. A dual degree is when a graduated student in a BA/MA program receives a bachelor's degree and a master's degree simultaneously. The degree code will not appear on the diploma. That is used to return the appropriate degree type on the diploma. (See FIG. 4.)

### Schoolcode Table

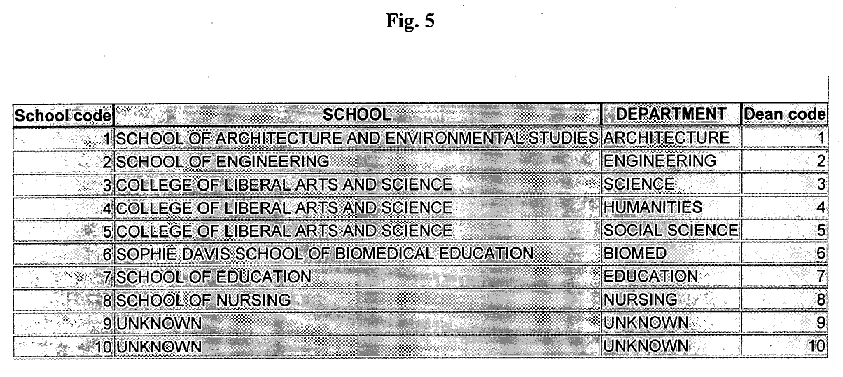

Depending on the college, there can be numerous schools at the college. This can be School of Engineering, School of Education, College of Liberal Arts and Science, etc. The school code defines what school will appear on the diploma. The Department field will not appear on diploma. This is used for searching purposes. The Dean code will not appear on diploma, this is linked to the Dean's signature field. (See FIG. 5.)

### Deancode Table

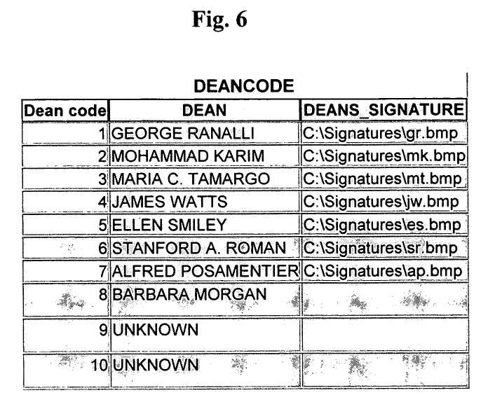

Depending on the college, there is a dean for each school and that dean's signature is printed on the diploma. The dean code returns the appropriate deans signature to be printed on the diploma. The field titled “DEANS_SIGNATURE” is a path, which points to the “c” drive on the computer in a folder called “signatures. These signatures are stored as bitmap images. (See FIG. 6)

### Setup

Before diplomas can be printed, the school's official signatures must be scanned and stored in a folder called “signatures” and stored on the computer. Depending on the school's requirements, the signatures can vary by department, dean, students major, etc. When the diplomas are printed, they will have the appropriate signatures on them. DIPLOMAS EXPRESS will place the right deans signature on their diploma based on their major code.

### Search Student Information

In this section, the operator can search for a student by Student ID or Last name. There are scroll buttons that will take the operator to the first name in the database, the last name in the database and in-between. If the operator needs information on how to use the database, there is a “Help” button. This help feature provides additional information to the user. A new student can be added manually by pressing “Add student.” This will clear all fields to prepare the database for a new entry. The “Delete” button will delete the student that is displayed on the form. A warning will appear asking the user if they want to delete the student.

### Required Fields

There are other fields that must be populated by the operator to facilitate diploma printing: 1—Graduation date. This is entered in words then the tab key in pressed to coerce the date in words to upper case. 2—Graduated checkbox (required). If a check is not placed in this box, a diploma will not be printed. 4—Honors College (If applicable). This box is checked for outstanding students who meet certain academic excellence. When this box is checked, “Honors College” will be added to their diploma. This is used in conjunction with the honors drop-down box. 5—Duplicate (Used for replacement diplomas). 6—Honors. If honors apply to the student, the operator must apply the right honors from the drop-down box. The choices are cum laude, magna cum laude, and summa cum laude and honors. When these boxes are checked and populated, the “Diploma Information” section auto-populates as well.

### Import/Export Student Information

There are command buttons on the form that will automate certain operations. “Import Students” button will import the excel file containing the students' information from the desktop into DIPLOMAS EXPRESS. After the operator has graduated each student, and diplomas are printed, the button titled “Export Students” is pressed to export an excel file to the desktop for archiving. Pressing “Purge Student” purges the database. The operator will be presented with two warning messages before the database is purged.

### Diploma Printing

This is where diplomas are printed. The operator will see a print preview before printing all diplomas. “Single will print preview the students' diploma you are looking at. “All” print previews all diplomas. “Dual Degrees” print previews students who receive a BA and MA simultaneously. “Advanced Certificates” will be print previewed as well. “Diploma report” provides a list of all students graduated. When the operator has print previewed the diplomas, the operator presses “Ctrl P” on the keyboard then a window will appear called “Print” with various choices. The choices are: 1—They can select the printer if they are on a network or local. 2—Print Range: The choices are All (Prints all diplomas), Pages “from” and “to”. If the operator wants to print only a specific range of diplomas, then the “from” and “to” can be used. Then press OK. The printing process will start. To return to the main form, the operator presses “Esc”.

### Additional Information

In this field the operator can enter relevant information about a student. Information entered in this field will not appear on their diploma.

### Detailed Information on Relationships

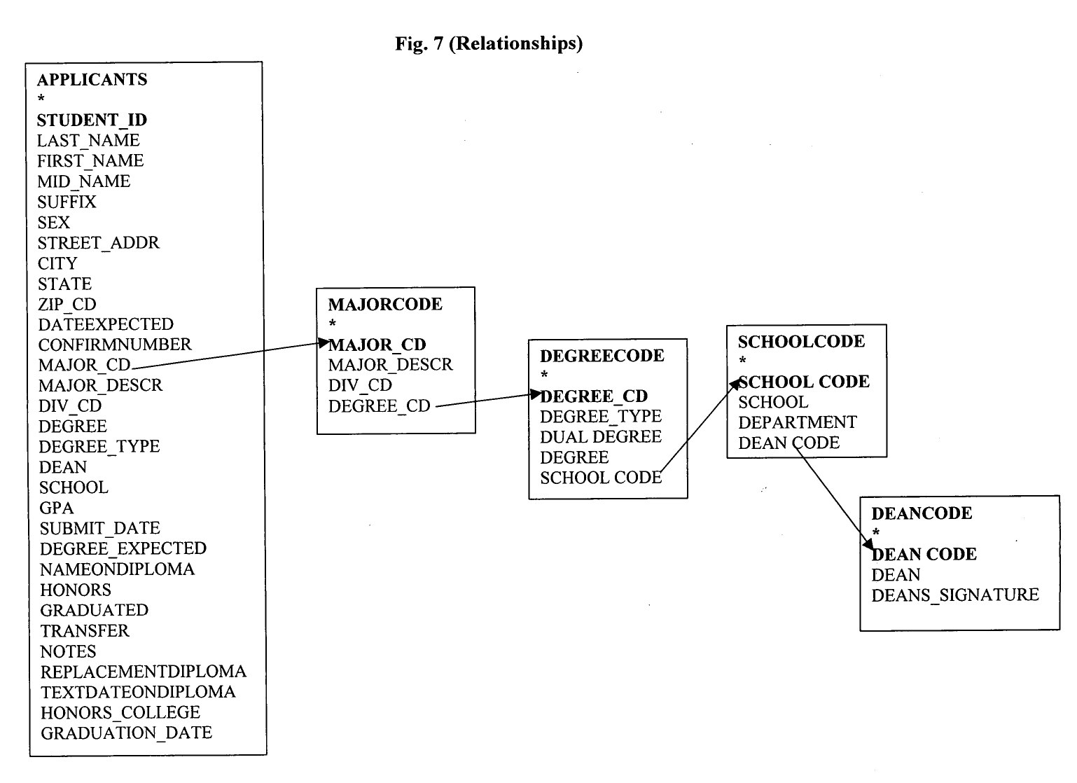

The major code table is of primary importance in DIPLOMAS EXPRESS. The applicants table has a field called majorcode. This is connected via a relationship to a field called MAJOR_CD in a table called majorcode. This majorcode table is connected via a relationship to a field called DEGREE_CD in a table called degreecode. This degreecode table is connected via a relationship to a field called SCHOOL_CODE in a table called schoolcode. This schoolcode table is connected to another table via a relationship to a field called DEAN_CD in a table called deancode. See FIG. 7 for complete picture. The majorcode table contains information on major description called MAJOR_DESCR, division called DIV_CD and degreecode called DEGREE_CD. The degreecode table contains information on degree type called DEGREE_TYPE, dual degree, degree and school code. The schoolcode table contains information on school, department and deancode. The deancode table contains information on dean and DEANS_SIGNATURE.

### Quieries

The auto-populating of Major, Division, Degree, Department, School, Degree type and Dean fields in DIPLOMAS EXPRESS is based on a query. The name of the query is called AllApplicants. This is of primary importance. The main query is the three-digit alphanumeric code which is defined in the major code table. There are five tables which are connected via relationships. They are: applicants, majorcode, degreecode, schoolcode and deancode. (See Main Query Bitmap Image). The applicants table holds the student information such as: ID number, name, majorcode, degree, degreetype, school, department, dean, GPA, honors, and name on diploma. When the majorcode is entered in the majorcode field, major description, degree type, division, school and dean are automatically populated. These fields populate due to the defined relationships between each table. This also eliminates data entry errors for the operator.

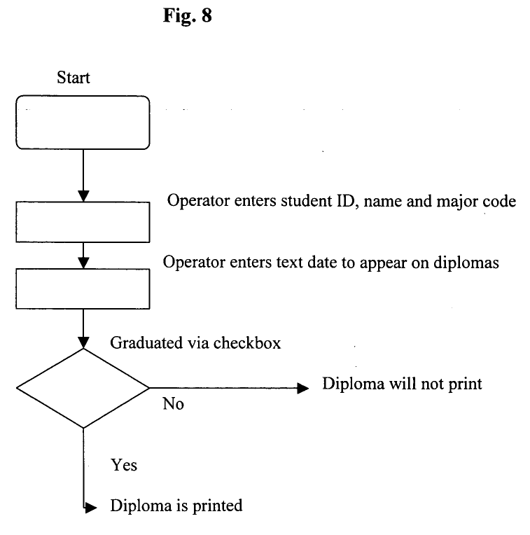

For flowchart representation of DIPLOMAS EXPRESS, see FIG. 8.

1. I am claiming that this program prints diplomas based on a students' three-digit alphanumeric major code. This is achieved with a query, which prints the appropriate School, Degree Type and Deans signature on the diploma.
